(19) United States
(12) Patent Application Publication
(10) Pub. No.: US 2025/0279527 A1
(43) Pub. Date: Sep. 4, 2025

(54) BATTERY PACK TRAVEL CHARGER AND BATTERY PACK HOLDER

(71) Applicant: MILWAUKEE ELECTRIC TOOL CORPORATION, Brookfield, WI (US)

(72) Inventors: Roque M. CORPUZ, JR., Sheboygan, WI (US); Duane W. WENZEL, Mukwonago, WI (US); Colten R. JAEKEL, Pewaukee, WI (US); Lin LEI, DongGuan City (CN); Yu Heng WEN, Wuhan City (CN); Lin CHEN, ShangRao City (CN); Jonathan S. PINSKE, Pewaukee, WI (US); Jing SU, LongYan City (CN); Wesley F. THOMAS, Milwaukee, WI (US)

(21) Appl. No.: 19/032,627

(22) Filed: Jan. 21, 2025

(30) Foreign Application Priority Data
Feb. 29, 2024 (CN) 202410230532.8

(51) Int. Cl. H01M 50/247; A41D 13/005; H01M 50/213; H01M 50/284; H01M 50/296

(52) U.S. Cl. CPC H01M 50/247; A41D 13/0051; H01M 50/213; H01M 50/284; H01M 50/296

(57) ABSTRACT

A battery pack accessory including a cylindrical housing, a terminal block configured to connect to a battery pack, an output port provided on the housing for providing an output current to a heated garment, and a controller located within the cylindrical housing and including an electronic processor and a memory. The controller is coupled to the terminal block and the output port. The controller is configured to determine that the battery pack is connected to the terminal block, determine that the heated garment is coupled to the battery pack accessory at the output port, and provide the output current to the heated garment in response to determining that the battery pack is connected to the terminal block and the heated garment is coupled to the battery pack accessory at the output port.

### CROSS-REFERENCE TO RELATED APPLICATIONS

This application claims priority to Chinese Patent Application No. 202410230532.8, filed on Feb. 29, 2024, the entire contents of which are incorporated herein by reference.

### FIELD

The present disclosure relates to battery packs and, more particularly, to a travel charger and a holder for a battery pack.

### SUMMARY

Battery packs provide power sources for devices of varying sizes and in varying locations based on the portability of the battery packs. For example, battery packs may provide power to a power tool, heated gear, and handheld devices, such as, for example, mobile phones and tablets. With respect to heated gear, such as a heated garment, a compact battery pack may be used over a larger, bulkier battery so as not to constrain the user's movement while wearing the heated gear. The compact battery pack may be recharged using a battery pack charger, which may be external to the heated gear or incorporated into the gear.

A battery pack, such as a compact battery pack used with heated gear, may be used with a battery pack holder. For example, with respect to heated gear, the gear may include a compact, exterior device with a port or recess for receiving the compact battery pack and a heated gear power port providing power to the heated gear as discharged by the battery pack. Similar to the battery pack charger, the battery pack holder may be incorporated in the heated gear or external to the heated gear.

The present disclosure provides, among other things, a travel battery pack charger and a corresponding battery pack holder for a compact battery pack. The travel battery pack charger and the battery pack holder include ports for providing power to heated gear. In some embodiments, the travel battery pack charger also includes an additional port, separate from the port that provides power to the heated gear for providing power to an external device, such as, for example, a mobile phone, a power tool, a laptop, a tablet, a smart wearable device, etc. The compact size of the travel battery pack charger and battery pack holder provides a minimal amount of additional weight to heated gear, and, thus, does not hinder the user's movement as much as larger and bulkier battery packs and associated accessories (e.g., chargers and holders).

For example, some embodiments described herein provide a battery pack accessory. The battery pack accessory includes a cylindrical housing, a terminal block configured to connect to a battery pack, an output port provided on the housing for providing an output current to a heated garment, and a controller located within the cylindrical housing and including an electronic processor and a memory. The controller is coupled to the terminal block and the output port. The controller is configured to determine that the battery pack is connected to the terminal block, determine that the heated garment is coupled to the battery pack accessory at the output port, and provide the output current to the heated garment.

A further embodiment described herein provides a system. The system includes a battery pack, and a battery pack accessory. The battery pack accessory including a cylindrical housing, a terminal block supported by the cylindrical housing and configured to connect to the battery pack, an output port provided on the cylindrical housing for providing an output current to a heated garment, and a controller located within the cylindrical housing and including an electronic processor and a memory. The controller is coupled to the terminal block and the output port and is configured to determine that the battery pack is connected to the terminal block, determine that the heated garment is coupled to the battery pack accessory at the output port, and provide the output current to the heated garment in response to determining that the battery pack is connected to the terminal block and determining that the heated garment is coupled to the battery pack accessory at the output port.

A further embodiment described herein provides a method of providing an output current to a heated garment from a battery pack. The method includes determining, with a controller of a battery pack accessory, that the battery pack is connected to a terminal block of the battery pack accessory, determining, with the controller of the battery pack accessory, that the heated garment is coupled to the battery pack accessory, wherein the heated garment is coupled to the battery pack accessory at an output port, and in response to determining that the battery pack is connected to the terminal block and the heated garment is coupled to the battery pack accessory at the output port, providing, with the controller of the battery pack accessory, a first output current from the battery pack to the heated garment.

Other features and aspects of the invention will become apparent by consideration of the following detailed description and accompanying drawings.

### BRIEF DESCRIPTION OF THE DRAWINGS

FIG. 1 illustrates a battery pack for powering a heated garment, according to some embodiments.

FIG. 2 illustrates a front view of a heated garment, according to some embodiments.

FIG. 3 illustrates a back view of a heated garment, according to some embodiments.

FIG. 4 illustrates another heated garment, according to some embodiments.

FIGS. 5A and 5B each illustrate a travel battery pack charger for the battery pack of FIG. 1, according to some embodiments.

FIG. 6 illustrates a first internal view of the travel battery pack charger of FIG. 5A or 5B, according to some embodiments.

FIG. 7 illustrates a second internal view of the travel battery pack charger of FIG. 5A or 5B, according to some embodiments.

FIG. 8 illustrates a battery pack holder for the battery pack of FIG. 1, according to some embodiments.

FIG. 9 illustrates a first internal view of the battery pack holder of FIG. 8, according to some embodiments.

FIG. 10 illustrates a second internal view of the battery pack holder of FIG. 8, according to some embodiments.

FIG. 11 is a block control diagram of the travel battery pack charger of FIG. 5A or 5B, according to some embodiments.

FIG. 12 is a block control diagram of the battery pack holder of FIG. 8, according to some embodiments.

FIG. 13 is a block control diagram of a heated garment, according to some embodiments.

FIG. 14A illustrates a dual connector from the heated garment of FIG. 2, according to some embodiments.

FIGS. 14B and 14C each illustrate a dual connector port for the travel battery pack charger of FIG. 5A or 5B, according to some embodiments.

FIG. 14D illustrates a dual connector port for the battery pack holder of FIG. 8, according to some embodiments.

FIG. 15 illustrates a user interface for the heated garment of FIG. 2, according to some embodiments.

FIG. 16 illustrates a user interface for the travel battery pack charger of FIG. 5A or 5B, according to some embodiments.

FIG. 17 illustrates a power distribution system for the travel battery pack charger of FIG. 5A or 5B, according to some embodiments.

FIG. 18 illustrates a power distribution system for the battery pack holder of FIG. 8, according to some embodiments.

FIG. 19 is a flow chart illustrating a method of operating the travel battery pack charger of FIG. 5A or 5B, according to some embodiments.

FIG. 20 is a flow chart illustrating a method of operating the battery pack holder of FIG. 8, according to some embodiments.

### DETAILED DESCRIPTION

Before any embodiments are explained in detail, it is to be understood that the embodiments are not limited in its application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,”

“substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%, or more) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

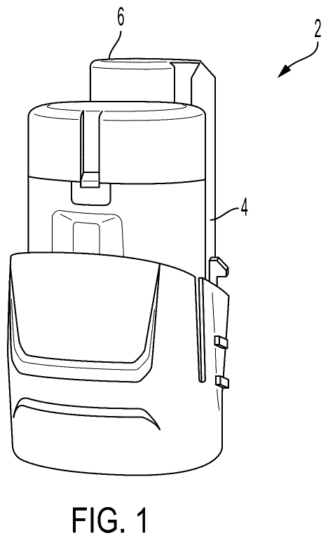

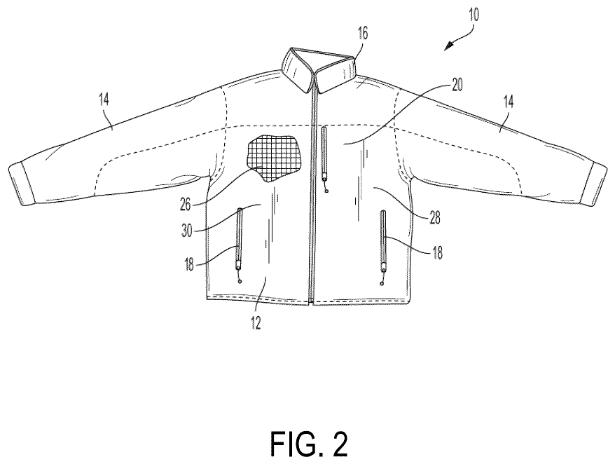

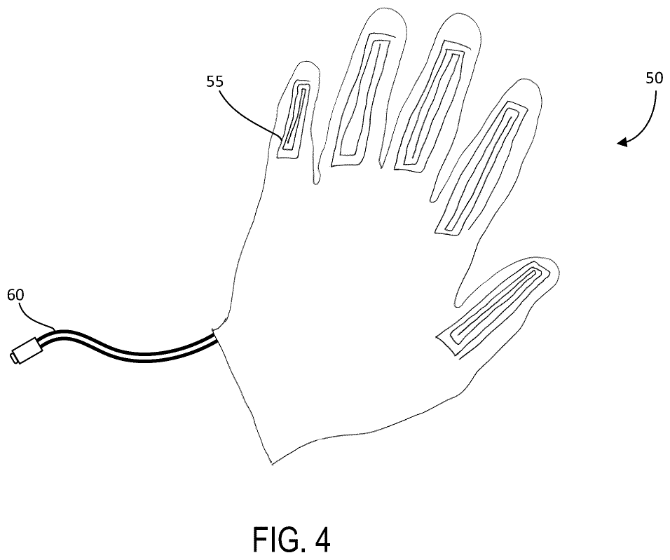

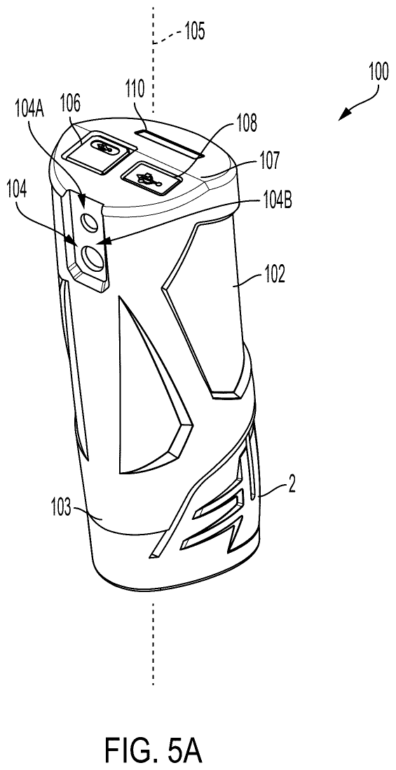

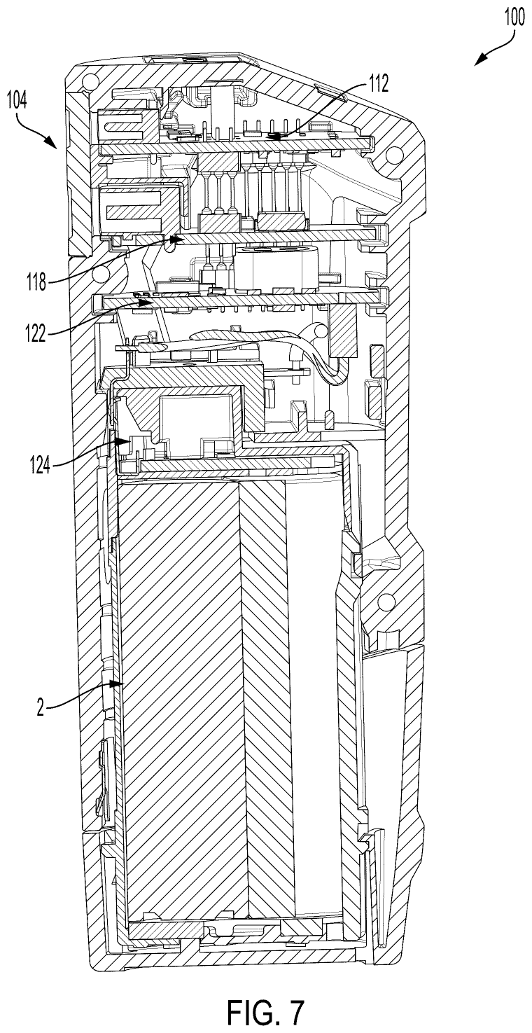

FIG. 1 illustrates a battery pack 2 for providing power to and communicating with a heated garment, such as heated jacket 10 (FIG. 2), a heated glove 50 (FIG. 4), and/or other type of garment or gear. The battery pack 2 includes a housing 4 and an interface portion 6 for connecting the battery pack 2 to one of a travel battery pack charger 100 (FIGS. 5A and 5B), a battery pack holder 200 (FIG. 8), and a power tool. Additionally, in some embodiments, the interface portion 6 may be configured for connecting the battery pack 2 to a heated garment (e.g., the heated jacket 10 and/or heated glove 50). In some embodiments, the battery pack 2 includes a connection port for receiving input power to charge rechargeable battery cells within the housing 4. For example, the connection port may be one of a Universal Serial Bus (USB), Universal Serial Bus Type-C (USB-C), or a Universal Serial Bus Power Delivery (USB-PD) port.

In some embodiments, the battery pack 2 includes one or more lithium-ion battery cells. In other embodiments, the battery pack 2 may be of a different chemistry, for example, nickel-cadmium, nickel-metal hydride, and the like. The battery cells may take various shapes and configurations. For example, in some embodiments, the battery cells may include one or more cylindrical cells, one or more pouch cells, one or more prismatic cells, or a combination thereof. In some embodiments, the battery pack 2 may include anywhere in the range of three to six battery cells 15. In some embodiments, the battery pack 2 may include two large 10 ampere-hours (A/hr), 3.7 volt (V) battery cells. These larger-sized battery cells provide an increased runtime in comparison to conventional battery cells. In some embodiments, the battery cells may be 74 watts-hour (W/hr) battery cells. In some embodiments, the increase in W/hr of the battery cells would proportionally increase the runtime. For example, doubling the W/hr would double the runtime. In some embodiments, the density of the battery cells may be increased from conventional densities. In the illustrated embodiment, the battery pack 2 is a 12V battery pack outputting a constant 12V output. In other embodiments, the output voltage level of the battery pack 2 may be different. For example, the battery pack 2 may be a 4V battery pack, 18V battery pack, 28V battery pack, 40V battery pack, or another voltage. The battery pack 2 may also have various capacities (e.g., 3, 4, 5, 6, 8, or 12 A/hr). The output of the battery cells may be in the range of 3.0-6.0 Ampere-hours (Ah).

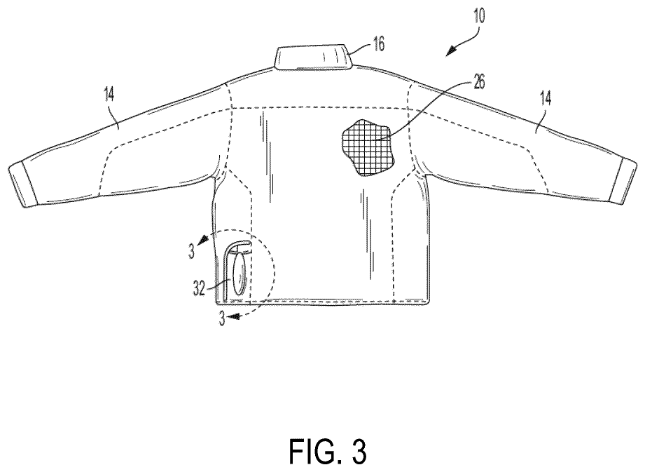

FIG. 2 illustrates a heated garment 10. The illustrated heated garment 10 is a heated jacket. The heated jacket 10 may be constructed in various sizes to fit a variety of users. The heated jacket 10 includes typical jacket features, such as, for example, a torso body 12, two arms 14, a collar 16, and one or more front pockets 18. As illustrated in cutaway portions of FIGS. 2 and 3, the heated jacket 10 includes a heater array 26. In some embodiments, the heater array 26 is disposed in both a left portion 28 and a right portion 30 of the torso body 12. In some embodiments, the heater array 26 may extend into the arms 14 and/or collar 16. The heater array 26 may be configured to generate heat based on a received DC voltage from the battery pack 2. In some embodiments, the heater array 26 may receive the DC voltage from the battery pack 2 via the travel battery pack charger 100 or the battery pack holder 200. For example, the heater array 26 may be a resistive heater array. However, other heater array types are also contemplated. In other embodiments, the heated jacket 10 may include a first heater array and second heater array arranged as an upper module and a lower module, respectively. In the illustrated embodiment, the heater array 26 is controlled by one of the battery pack 2 and the heated jacket 10 based on input from an external device. In other embodiments, multiple heater arrays may be controlled individually via a single control input or multiple control inputs. For example, the multiple heater arrays may be isolated and controlled by the battery pack 2 based on input from the device. The heater array 26 may include resistive heating coils formed of carbon fibers, high density carbon fibers, or other heating devices. In some embodiments, the heated jacket 10 is configured to maintain a temperature of up to 110 degrees) (° Fahrenheit, although in other embodiments, lower or greater temperatures are possible depending upon the type of heater array 26.

In some embodiments, the heater array 26 may include a negative temperature coefficient thermistor (NTC) or a positive temperature coefficient thermistor (PTC) to determine temperature. For example, the NTC or PTC is coupled to the heater array 26 to determine the heater array 26 temperature. In some embodiments where a carbon fiber element is implemented in the heated garment, an NTC or PTC may be used. The NTC or PTC may be added to the heater array 26 on or close to the carbon fiber element and an ambient surface of the garment. In some embodiments where a conductive ink heater is implemented in a heated garment, the current required to provide heat to the heater array may be determined by a current sensor. For example, a PTC may be provided to the heater array which reduce the current drawn by the heater array as the temperature of the heater array increases.

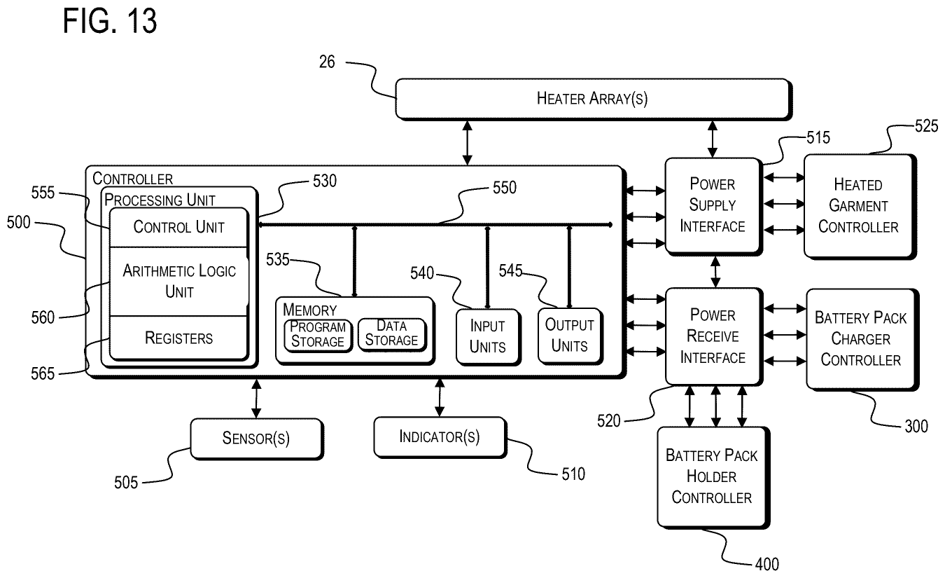

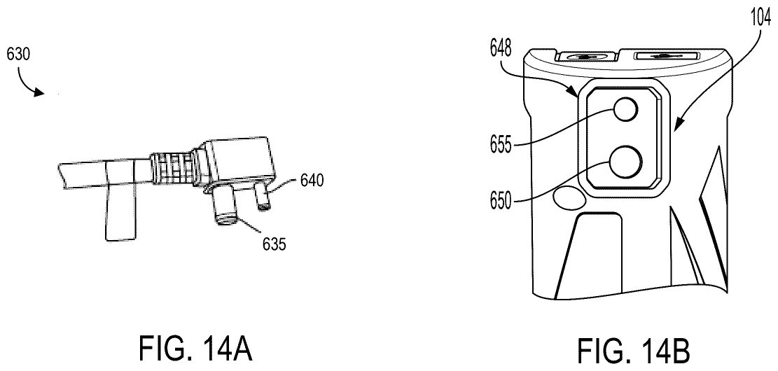

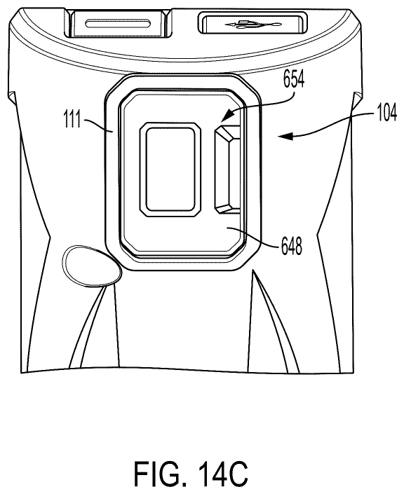

As illustrated in cutout 3-3 of FIG. 3, the heated jacket 10 includes a compartment 32 located on a lower portion of the back torso body. The compartment 32 houses an electrical component, such as the battery pack 2, which may be held within one of the travel battery pack charger 100 and the battery pack holder 200. The heated jacket 10 includes a connector, such as dual connector 630 (FIG. 14A), for connecting the heater arrays 26 to one of the travel battery pack charger 100 and the battery pack holder 200.

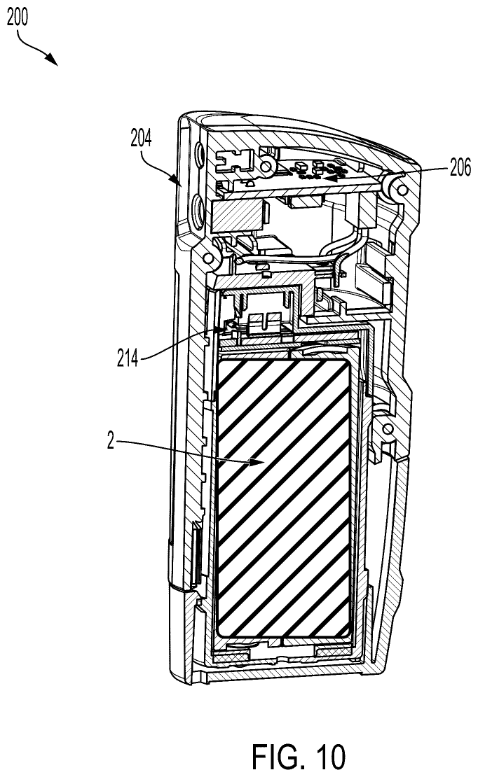

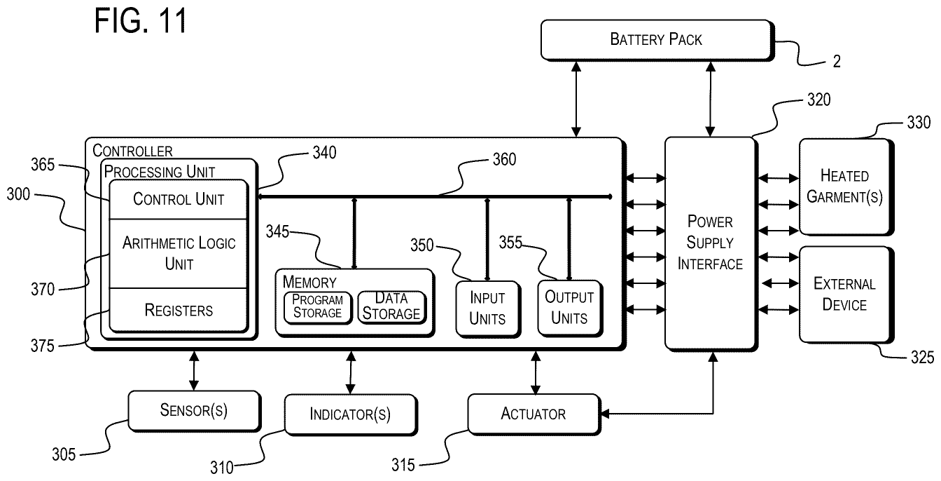

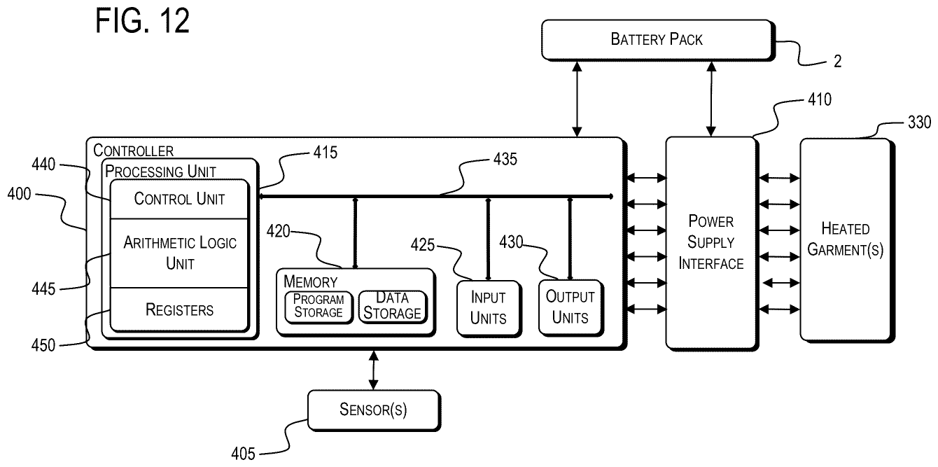

In some embodiments, the heated jacket 10 may include a controller, such as controller 400 (FIG. 12). The controller 400 may communicate with one of a travel battery pack charger controller, such as controller 300 (FIG. 11), and a battery pack holder controller, such as controller 500 (FIG. 13). In some embodiments, the heated jacket 10 may include at least one connection port for connecting to other heated garments. For example, the connection port(s) may be a USB, USB-C, or USB-PD port. The connection port(s) may be located on the torso body 12, arms 14, and/or collar 16 of the heated jacket 10. Garments connected to the heated jacket 10 via the connection port may receive input power from the battery pack 2 and may be controlled by one of the travel battery pack charger 100 (specifically, by the travel battery pack charger controller 300) and the battery pack holder 200 (specifically, by the battery pack holder controller 500) that is connected to the heated jacket 10.

FIG. 4 illustrates another heated garment 50. The illustrated heated garment 50 is a heated glove. The heated glove 50 includes a heater array 55 and a connector 60. For example, the connector 60 may be a USB, USB-C, or USB-PD plug. The connector 60 may electrically and, optionally, communicatively couple the heated glove 50 to the heated jacket 10. The heater array 55 may be powered and controlled by the battery pack 2 that is coupled to the heated jacket 10. For example, the heater array 55 may be able to provide varying heating levels to a user wearing the heated glove 50 based on input from the battery pack 2 that receives input from the external device. In some embodiments, the heated glove 50 may be a mitten.

FIG. 5A illustrates the travel battery pack charger 100 (hereinafter “charger 100”). The charger 100 includes a housing 102, an output port 104, a cover 106 for a bi-directional port, a power button 108, and a fuel gauge 110. In some embodiments, the charger 100 is substantially cylindrical. The battery pack 2 is received at a first end 103 of the charger 100. The battery pack 2 and the charger 100 have similar outer configurations (e.g., shapes and sizes) such that the battery pack 2 and the charger 100 create a generally continuous outer surface when the battery pack 2 is connected to the charger 100. The first end 103 of the charger 100 is perpendicular to a longitudinal axis 105 of the battery pack 2 and the charger 100. In some embodiments, the first end 103 is not a linear line around a circumference of the housing 102. For example, the first end 103 may be an open end of the housing that follows a substantially stepped and sloped line. The cover 106, the power button 108, and the fuel gauge 110 are arranged on a second end 107 of the charger 100, parallel to the first end 103 of the charger 100. In some embodiments, the second end 107 may include a first flat portion and a second, slightly sloped portion. The output port 104 may be a dual barrel port including a first barrel and a second barrel provided adjacent to one another along the longitudinal axis 105. In some embodiments, the output port 104 provides output power from the battery pack 2 to the heated jacket 10. For example, the output port 104 may provide 26 Watts (W) to the heated jacket 10 from the battery pack 2. In some embodiments, the fuel gauge 110 visually indicates a power level of the battery pack 2.

FIG. 5B illustrates the charger 100 according to an alternative implementation. In particular, FIG. 5B illustrates a ridge 111 positioned around the output port 104 that extends laterally from the longitudinal axis 105. The ridge 111 may take various shapes and sizes and may be positioned entirely around the output port 104 or around at least a portion of the output port 104. The ridge 111 may protect a dual connector connected to the output port 104 and, in some implementations, may be sized and/or shaped to interface with the dual connector. As illustrated in FIG. 5B, in some implementations, the ridge 111 is also positioned around an attachment member 112 (e.g., a slot, a hinge, a pivot point, etc.) configured to attach to a door or cover for the output port 104 (e.g., a door or cover for a cavity formed via the ridge 111). Further details regarding covers for the output port 104 are provided below with respect to FIGS. 14B and 14C.

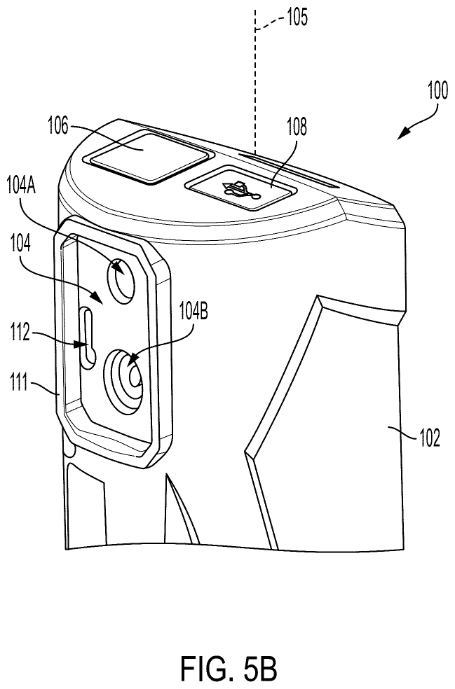

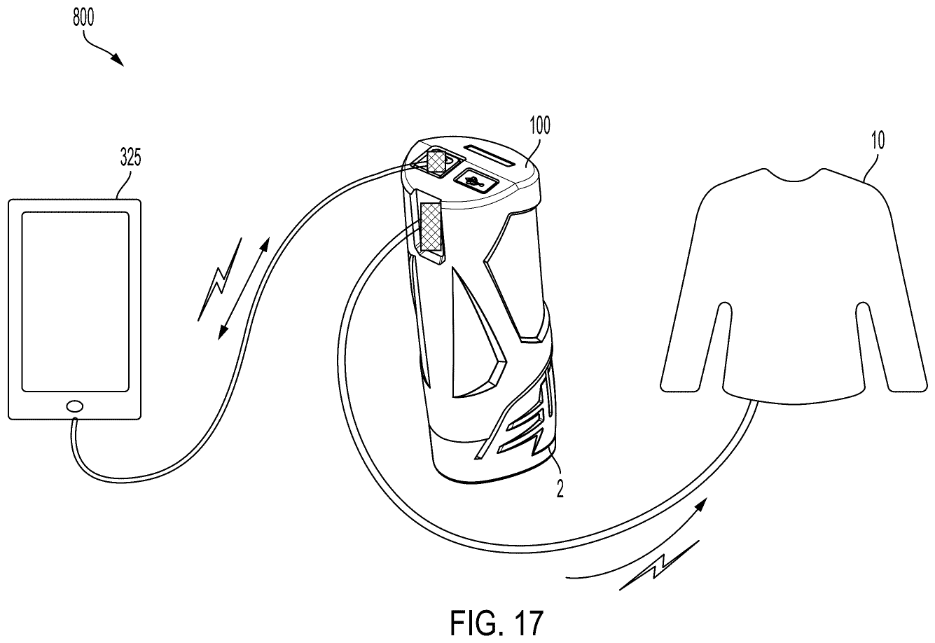

In some embodiments, the cover 106 is a removable cover. For example, the cover 106 provides a barrier between a bi-directional port, such as bi-directional port 114 (FIG. 6), and the environment around the charger 100. In some embodiments, the cover 106 is made of a rubber material. For example, the material may be Fluorosilicone rubber that is resistant to chemicals and solvents and has an operating range of −60° to 200°° C. In some embodiments, the bi-directional port 114 is a USB-C port. In some embodiments, the power button 108 may be depressed to control a flow of power from the battery pack 2 to a device, such as device 325 (FIG. 17), which may be a mobile phone, a power tool, a laptop, a tablet, a smart wearable device, or the like. In other embodiments, the power button 108 may be a slidable switch or a rotatable dial. In some embodiments, power may be simultaneously provided from the battery pack 2 to the heated jacket 10 via the output port 104 and to the device 325 via the bi-directional port 114. The battery pack 2 may receive a charging voltage from the charger 100 when the device 325 provides a charging voltage to the charger 100 via the bi-directional port 114. In some embodiments, the fuel gauge 110 illuminates in response to the charger 100 outputting a voltage and in response to the charger 100 receiving a voltage. For example, in a discharge mode, the fuel gauge 110 may illuminate a first color and, in a charge mode, the fuel gauge 110 may illuminate a second color that is different than the first color. As also described above, in some embodiments, an indicator, such as, for example, the power button 108, may provide information regarding a status of the bi-directional port 114.

FIG. 6 illustrates a first internal view of the charger 100. The charger 100 includes a first printed circuit board (PCB) 112, a second PCB 118, a third PCB 122, and a terminal block 124. In some embodiments, the first PCB 112, the second PCB 118, the third PCB 122, and the terminal block 124 are stacked on top of one another along the longitudinal axis 105. For example, the first PCB 112 is provided nearest to the second end 107 of the charger 100 followed by the second PCB 118, the third PCB 122, and the terminal block 124 in that order.

The bi-directional port 114 and a communication port 116 are provided on the first PCB 112. The bi-directional port 114 may be provided directly underneath the cover 106. The communication port 116 may be a first port of the output port 104. In some embodiments, the communication port 116 may be provided above a first side of the first PCB 112. For example, the communication port 116 may not contact the first PCB 112. A heated garment voltage port 120 may be provided below a second side, opposite the first side, of the first PCB 112 and on the second PCB 118. In some embodiments, the heated garment voltage port 120 may contact the second side of the first PCB 112. The heated garment voltage port 120 may be a second port of the output port 104. In some embodiments, the heated garment voltage port 120 has a larger diameter than the communication port 116 and may be a different type of port than the communication port 116. Additional circuit components may be provided on the first PCB 112, the second PCB 118, the third PCB 122, or a combination thereof. The terminal block 124 may electrically and mechanically connect the battery pack 2 to the charger 100. For example, the terminal block 124 may include mechanical interface components and electrical interface components. In some embodiments, the terminal block 124 may be electrically connected to the first PCB 112, the second PCB 118, and the third PCB 122.

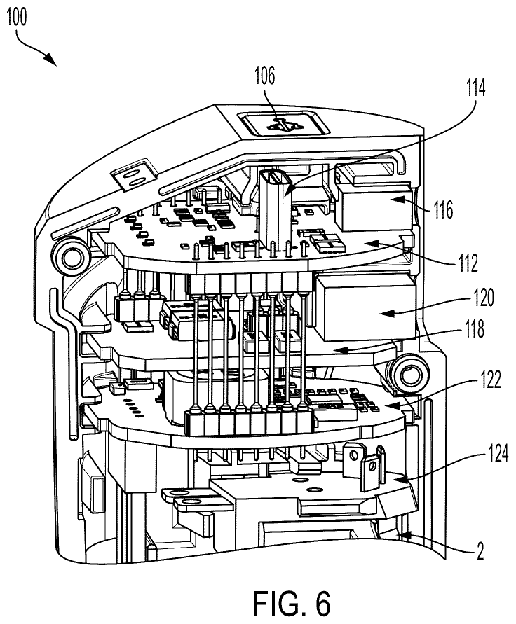

FIG. 7 illustrates a second internal view of the charger 100. The battery pack 2 is partially received within the charger 100 and connected to the terminal block 124 in a bottom portion of the charger. The first PCB 112, the second PCB 118, and the third PCB 122 are provided in a top portion of the charger 100.

FIG. 8 illustrates the battery pack holder 200 (hereinafter “holder 200”). The holder 200 includes a housing 202 and an output port 204. In some embodiments, the holder 200 is substantially cylindrical. The battery pack 2 is received at a first end 203 of the holder 200. The battery pack 2 and the holder 200 have similar outer configurations (e.g., shapes and sizes) such that the battery pack 2 and the holder 200 create a generally continuous outer surface when the battery pack 2 is connected to the holder 200. The first end 203 of the holder 200 is perpendicular to a longitudinal axis 205 of the battery pack 2 and the holder 200. In some embodiments, the first end 203 is not a linear line around a circumference of the housing 202. For example, the first end 203 may be an open end of the housing 203 that follows a substantially stepped and sloped line. The output port 204 may be a dual barrel port including a first barrel and a second barrel provided adjacent to one another along the longitudinal axis 205 adjacent to a second end 209 of the holder 200. In some embodiments, the second end 209 may include a first flat portion and a second, slightly sloped portion. In some embodiments, the output port 204 provides output power from the battery pack 2 to the heated jacket 10. For example, the output port 204 may provide 26 Watts (W) to the heated jacket 10 from the battery pack 2.

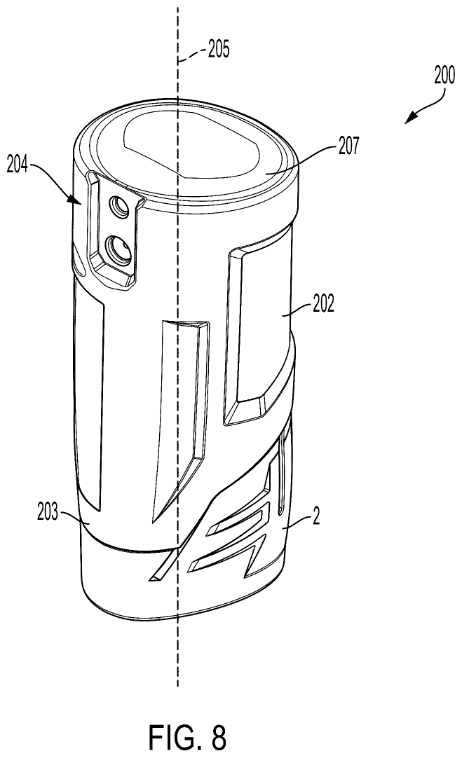

FIG. 9 illustrates a first internal view of the holder 200. The holder 200 includes a PCB 206, a communication port PCB 208, a communication port 210, a heated garment voltage port 212, and a terminal block 214. The communication port PCB 208 is provided adjacent to the communication port 210. In some embodiments, the communication port PCB 208 is fixed to the communication port 210 with a screw. In some embodiments, the communication port PCB 208 and the communication port 210 are spaced apart from a first side of the PCB 206. In some embodiments, the communication port 210 is a first port of the output port 204. The heated garment voltage port 212 may extend from a second side, opposite the first side, of the PCB 206. In some embodiments, the heated garment voltage port is a second port of the output port 204. In some embodiments, the heated garment voltage port 212 has a larger diameter than the communication port 210 and may be a different type of port than the communication port 210. Additional circuit components may be provided on the PCB 206. The terminal block 214 may electrically and mechanically connect the battery pack 2 to the holder 200. For example, the terminal block 214 may include mechanical interface components and electrical interface components. In some embodiments, the terminal block 214 may be electrically connected to the PCB 206.

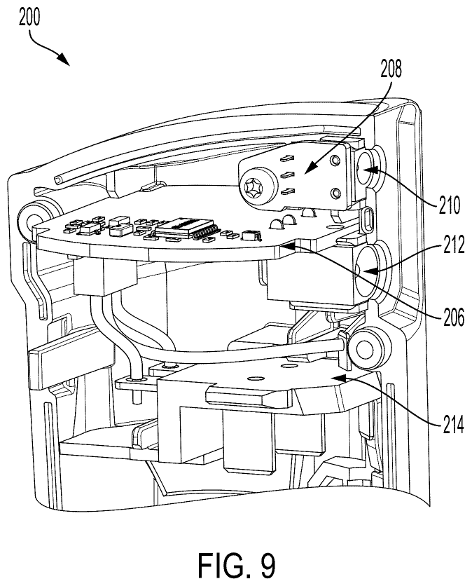

FIG. 10 illustrates a second internal view of the holder 200. The battery pack 2 is partially received within the holder 200 and connected to the terminal block 214 in a bottom portion of the charger. The PCB 206 is provided in a top portion of the holder 200.

A controller 300 for the charger 100 is illustrated in FIG. 11. The controller 300 is electrically and/or communicatively connected to a variety of modules or components of the charger 100. For example, the illustrated controller 300 is connected to one or more sensors 305 (which may include, for example, one or more current sensors, voltage sensors, temperature sensor, etc., or a combination thereof), one or more indicators 310, an actuator 315, a power supply interface 320, and the battery pack 2. In some embodiments, the one or more indicators 310 may include the fuel gauge 110.

The controller 300 includes a plurality of electrical and electronic components that provide power, operational control, and protection to the components and modules within the controller 300 and/or the charger 100. For example, the controller 300 includes, among other things, a processing unit 340 (e.g., a microprocessor, an electronic processor, an electronic controller, a microcontroller, or another suitable programmable device), a memory 345, one or more input units 350, and one or more output units 355. In some embodiments, the processing unit 340 includes, among other things, a control unit 365, an arithmetic logic unit (“ALU”) 370, and a plurality of registers 375 (shown as a group of registers in FIG. 11), and is implemented using one or more computer architectures (e.g., a modified Harvard architecture, a von Neumann architecture, etc.). The processing unit 340, the memory 345, the input units 350, and the output units 355, as well as the various modules connected to the controller 300 are connected by one or more control and/or data buses (e.g., common bus 360). The control and/or data buses are shown generally in FIG. 11 for illustrative purposes. The use of one or more control and/or data buses for the interconnection between and communication among the various modules and components would be known to a person skilled in the art in view of the embodiments described herein.

The memory 345 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 340 is connected to the memory 345 and executes software instructions that are capable of being stored in a RAM portion of the memory 345 (e.g., during execution), a ROM portion of the memory 345 (e.g., on a generally permanent basis), or another non-transitory computer readable medium, such as another memory or a disc. Software included in the implementation of the charger 100 can be stored in the memory 345 of the controller 300. The software includes, for example, firmware, one or more applications, program data, filters, rules, one or more program modules, and other executable instructions. The controller 300 (e.g., the processing unit 340) is configured to retrieve from the memory 345 and execute, among other things, instructions related to the control processes and methods described herein. In other embodiments, the controller 300 includes additional, fewer, or different components.

The sensors 305 may include one or more current sensors, voltage sensors, temperature sensor, etc. that provide overcurrent protection for the charger 100, the battery pack 2, and anything receiving/providing power at the power supply interface 320 (e.g., heated garment(s) 330 or an external device 325). In some embodiments, the sensors 305 may determine a charge level of the battery pack 2.

The indicators 310 receive control signals from the controller 300 to turn ON and OFF or otherwise convey information based on different states of the charger 100, the heated garment 330, the battery pack 2, or a combination thereof. For example, the indicators 310 may display the power level of the battery pack 2, that the charger 100 is in a discharge mode, or that the charger 100 is in a charge mode. The indicators 310 include, for example, one or more light-emitting diodes (LEDs), a display screen (e.g., an LCD display), or a combination thereof. The display/indicator(s) 310 may also include additional elements to convey information to a user through one or more audible outputs, tactile outputs (e.g., a speaker), or a combination thereof. The display/indicator(s) 310 may also be referred to as an output device configured to provide an output to a user. In some embodiments, the indicators 310 may illuminate to display a power level of the battery pack 2 when the charger 100 is providing a charging voltage to the battery pack 2 or when the charger 100 is providing an output voltage to a heated garment 330 and/or and external device 325. In some embodiments, the controller 300 determines that a heated garment 330 is connected to the power supply interface 320 and automatically illuminates the indicators 310 to display a power level of the battery pack 2.

The actuator 315 may be a power button, such as power button 108 (FIGS. 5A and 5B). The actuator 315 may provide a signal to the controller 300 when a user depresses the power button 108. For example, the signal may be an ON/OFF signal for providing power to or ceasing the power to a device 325 coupled to the power supply interface 320. As noted above, in some embodiments, the charger 100 may charge a device 325 (e.g., a mobile phone, a power tool, a laptop, a tablet, a smart wearable device, etc.). In some embodiments, the power button 108 may control power to the heated garment 330, the external device 325, or a combination thereof and, in some embodiments, also or alternatively control power to and/or from the battery pack 2.

The power supply interface 320 is connected to the controller 300 and couples to one or more heated garments 330 (e.g., heated jacket 10 and/or heated glove 50), a device 325, and the battery pack 2. In some embodiments, the power supply interface 320 includes a first connection port, such as output port 104, that couples to the heated garment 330, a second connection port, such as bi-directional port 114, that couples to the device 325, and a third connection port, such as the terminal block 124, that couples to the battery pack 2. The power supply interface 320 includes a combination of mechanical (e.g., output port 104, bi-directional port 114, terminal block 124) and electrical components configured to and operable for interfacing (e.g., mechanically, electrically, and communicatively connecting) the charger 100 with the heated garments 330, device 325, and battery pack 2. In some embodiments, the power supply interface 320 receives power from the battery pack 2 and transmits the power to the heated garments 330 and/or device 325, for example, in a discharge mode. Additionally, in some embodiments, the power supply interface 320 receives power from the device 325 and transmits the power to at least one of the battery pack 2 and the heated garments 330, for example, in either a charge mode or a charge mode and a discharge mode. The power supply interface 320 includes active and/or passive components (e.g., voltage step-down controllers, voltage converters, rectifiers, filters, etc.) to regulate or control the power transmitted to the heated garments 330, device 325, and/or battery pack 2.

A controller 400 for the holder 200 is illustrated in FIG. 12. The controller 400 is electrically and/or communicatively connected to a variety of modules or components of the holder 200. For example, the illustrated controller 400 is connected to one or more sensors 405 (which may include, for example, one or more current sensors, voltage sensors, temperature sensor, etc., or a combination thereof), a power supply interface 410, and the battery pack 2.

The controller 400 includes a plurality of electrical and electronic components that provide power, operational control, and protection to the components and modules within the controller 400 and/or the holder 200. For example, the controller 400 includes, among other things, a processing unit 415 (e.g., a microprocessor, an electronic processor, an electronic controller, a microcontroller, or another suitable programmable device), a memory 420, one or more input units 425, and one or more output units 430. In some embodiments, the processing unit 340 includes, among other things, a control unit 440, an arithmetic logic unit (“ALU”) 445, and a plurality of registers 450 (shown as a group of registers in FIG. 12), and is implemented using one or more computer architectures (e.g., a modified Harvard architecture, a von Neumann architecture, etc.). The processing unit 415, the memory 420, the input units 425, and the output units 430, as well as the various modules connected to the controller 400 are connected by one or more control and/or data buses (e.g., common bus 435). The control and/or data buses are shown generally in FIG. 12 for illustrative purposes. The use of one or more control and/or data buses for the interconnection between and communication among the various modules and components would be known to a person skilled in the art in view of the embodiments described herein.

The memory 420 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 415 is connected to the memory 420 and executes software instruction that are capable of being stored in a RAM portion of the memory 420 (e.g., during execution), a ROM portion of the memory 420 (e.g., on a generally permanent basis), or another non-transitory computer readable medium, such as another memory or a disc. Software included in the implementation of the holder 200 can be stored in the memory 420 of the controller 400. The software includes, for example, firmware, one or more applications, program data, filters, rules, one or more program modules, and other executable instructions. The controller 400 (e.g., the processing unit 415) is configured to retrieve from the memory 420 and execute, among other things, instructions related to the control processes and methods described herein. In other embodiments, the controller 400 includes additional, fewer, or different components.

The sensors 405 may include one or more current sensors, voltage sensors, temperature sensor, etc. that provide overcurrent protection for the holder 200, the battery pack 2, and anything receiving/providing power at the power supply interface 410 (e.g., heated garment(s) 330). In some embodiments, the sensors 405 may determine a charge level of the battery pack 2.

The power supply interface 410 is connected to the controller 400 and couples to one or more heated garments 330 (e.g., heated jacket 10 and/or heated glove 50) and the battery pack 2. In some embodiments, the power supply interface 410 includes a first connection port, such as output port 204, that couples to the heated garment 330 and a second connection port, such as the terminal block 214, that couples to the battery pack 2. The power supply interface 410 includes a combination of mechanical (e.g., output port 204 and terminal block 214) and electrical components configured to and operable for interfacing (e.g., mechanically, electrically, and communicatively connecting) the holder 200 with the heated garments 330 and battery pack 2. In some embodiments, the power supply interface 410 receives power from the battery pack 2 and transmits the power to the heated garments 330, for example, in a discharge mode. The power supply interface 410 includes active and/or passive components (e.g., voltage step-down controllers, voltage converters, rectifiers, filters, etc.) to regulate or control the power transmitted to the heated garments 330.

A controller 500 for a heated garment is illustrated in FIG. 13. The controller 500 is electrically and/or communicatively connected to a variety of modules or components of the heated garment, such as heated jacket 10 (FIG. 2). For example, the illustrated controller 500 is connected to one or more sensors 505 (which may include, for example, current sensors, voltage sensors, temperature sensor, timers, etc., or a combination thereof), one or more indicators 510, one or more heater arrays 26, a power supply interface 515, and a power receive interface 520. In some embodiments, the controller 500 may be connected to a heated garment wireless communication controller (not shown) included in the heated garment. For example, the heated jacket 10 may wirelessly communicate with the battery pack 2, the charger 100, the holder 200 or each via the heated garment wireless communication controller.

The controller 500 includes a plurality of electrical and electronic components that provide power, operational control, and protection to the components and modules within the controller 500 and/or heated garment. For example, the controller 500 includes, among other things, a processing unit 530 (e.g., a microprocessor, an electronic processor, an electronic controller, a microcontroller, or another suitable programmable device), a memory 535, input units 540, and output units 545. The processing unit 530 includes, among other things, a control unit 555, an arithmetic logic unit (“ALU”) 560, and a plurality of registers 265 (shown as a group of registers in FIG. 13), and is implemented using one or more computer architecture (e.g., a modified Harvard architecture, a von Neumann architecture, etc.). The processing unit 530, the memory 535, the input units 540, and the output units 545, as well as the various modules connected to the controller 500 are connected by one or more control and/or data buses (e.g., common bus 550). The control and/or data buses are shown generally in FIG. 13 for illustrative purposes. The use of one or more control and/or data buses for the interconnection between and communication among the various modules and components would be known to a person skilled in the art in view of the embodiments described herein.

The memory 535 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 530 is connected to the memory 535 and executes software instructions that are capable of being stored in a RAM portion of the memory 535 (e.g., during execution), a ROM portion of the memory 535 (e.g., on a generally permanent basis), or another non-transitory computer readable medium, such as another memory or a disc. Software included in the implementation of the heated garment can be stored in the memory 535 of the controller 500. The software includes, for example, firmware, one or more applications, program data, filters, rules, one or more program modules, and other executable instructions. The controller 500 is configured to retrieve from the memory 535 and execute, among other things, instructions related to the control processes and methods described herein. In other embodiments, the controller 500 includes additional, fewer, or different components.

The indicators 510 receive control signals from the controller 500 to turn ON and OFF or otherwise convey information based on different states of the heated garment 10. For example, the indicators 510 may display that the heater array 26 is ON, that the battery pack 2 is out of power, etc. The indicators 510 include, for example, one or more light-emitting diodes (LEDs), a display screen (e.g., an LCD display), or a combination thereof. The display/indicator(s) 515 may also include additional elements to convey information to a user through one or more audible outputs, tactile outputs (e.g., a speaker), or a combination thereof. The display/indicator(s) 510 may also be referred to as an output device configured to provide an output to a user.

The power supply interface 515 is connected to the controller 500 and couples to a heated garment controller 525. The power supply interface 515 supplies power from the battery pack 2 to another heated garment (i.e., the heated garment controller 215 included in such “other” heated garment). In some embodiments, the heated garment controller 525 may include at least some of the same components as the controller 500. As noted, the heated garment controller 525 is within a heated garment separate from the heated garment including the controller 500. For example, the controller 500 may be included in the heated jacket 10 (FIG. 2) and the heated garment controller 525 may be included in the heated glove 50 (FIG. 4). The power supply interface 515 includes a combination of mechanical (e.g., a connector) and electrical components configured to and operable for interfacing (e.g., mechanically, electrically, and communicatively connecting) the heated garment with another heated garment.

The power receive interface 520 is connected to the controller 500 and couples to the battery pack charger controller 300 or the battery pack holder controller 400 to receive power from the battery pack 2. The power receive interface 520 includes a combination of mechanical (e.g., a connector) and electrical components configured to and operable for interfacing (e.g., mechanically, electrically, and communicatively connecting) the heated garment with the charger 100 or the holder 200. In some embodiments, the power receive interface 520 also receives data from the charger controller 300 or the holder controller 400. For example, the controller 500 may receive a temperature control signal from the charger controller 300 or the holder controller 400 via the power receive interface 520.

In some embodiments, the power supply interface 515 facilitates both power and data transfer to the heated garment controller 525. However, in other embodiments, a separate interface may be used to communicate information between the controller 500, the charger 100, the holder 200, the battery pack 2, or other components of the heated garment 10 and the heated garment controller 525, including, for example, a wireless communication connection in some embodiments. For example, the charger controller 300 may provide a temperature control signal (e.g., processed or unprocessed) to the controller 500 and/or the heated garment controller 525 via the controller 500. The temperature control signal may include a portion associated with the controller 500 as well as a portion associated with the heated garment controller 525 and such portions may be associated with unique identifiers of each controller, which may allow the controller 500, the power supply interface 515, or other component in the heated garment 10 to determine what portion of the signal is intended for what controller and, as such, may forward the portion designated for the heated garment controller 525 via the power supply interface 515. In some embodiments, rather than indirectly communicating with the heated garment controller 525 through the controller 500, the charger 100 or the holder 200 may directly communicate with the heated garment controller 525 via one or more wired or wireless communication channels.

FIG. 14A illustrates a dual connector 630 from a heated garment, such as heated jacket 10 (FIG. 2). The dual connector 630 connects the heated jacket 10 to one of the charger 100 and the holder 200. In some embodiments, the dual connector 630 extends as a wire from the heated jacket 10. The dual connector 630 includes a dual barrel connection portion including a first connection portion 635 and a second connection portion 640. For example, the first connection portion 635 may be a barrel-style connector and the second connection portion 640 may also be a barrel-style connector that is smaller in diameter than the first connection portion 635. The first connection portion 635 facilitates power (e.g., 12V, 18W) from the battery pack 2 to the heater array 26 of the heated jacket 10 and the second connection portion 640 communications data to one of the charger 100, the holder 200, and the battery pack 2 from the heated jacket 10.

FIG. 14B illustrates the output port 104 of a battery pack charger, such as the charger 100 with a cover 648 positioned over the output port 104. The output port 104 receives the dual connector 630 from the heated jacket and facilitates an electrical connection between the battery pack 2 and the heated jacket 10. As illustrated in FIG. 14B, the cover 648 may include protrusions 650 and 655 that generally align with the two ports of the output port 104 (a first port 104A and a second 104B as illustrated in FIGS. 5A and 5B) that are accessible when the cover 648 is removed (e.g., removed via a snap or friction fit connection or pivoted or slid out of the position illustrated in FIG. 14B). The first port 104A receives the first connection portion 635 and the second port 104B receives the second connection portion 640. In some of the embodiments, the first port 104A is the heated garment voltage port 120 and the second port 104B is the communication port 116. In some embodiments, the first port 104A is a 12V power port that provides a 26 watt (W) output. In some embodiments, the output port 104 may have over current protection characteristics. For example, the over current protection characteristic enables the charger 100 to remain functional when an over-current event occurs. In some embodiments, the output port 104 may self-heal after the over-current event (e.g., after the dual connector 630 is disconnected from the output port 104).

FIG. 14C illustrates the charger 100 of FIG. 5B with a cover 648. In this implementation, the cover 648 may fit within the ridge 111 and may be attached (e.g., through a snap or friction fit with the attachment member 112). As illustrated in FIG. 14C, the cover 648 may include a detent or handle 654 that allows a user to grip the cover 648 and move the cover 648 to access the output port 104.

FIG. 14D illustrates the output port 204 of a battery pack holder, such as the holder 200. The output port 204 receives the dual connector 630 from the heated jacket and facilitates an electrical connection between the battery pack 2 and the heated jacket 10. The output port 204 includes a first port 660 and a second port 665. The first port 660 receives the first connection portion 635 and the second port 665 receives the second connection portion 640. In some of the embodiments, the first port 660 is the heated garment voltage port 212 and the second port 655 is the communication port 210. In some embodiments, the first port 660 is a 12V power port that provides a 26 watt (W) output. In some embodiments, the output port 204 may have over current protection characteristics. For example, the over current protection characteristic enables the holder 200 to remain functional when an over-current event occurs. In some embodiments, the output port 204 may self-heal after the over-current event (e.g., after the dual connector 630 is disconnected from the output port 204).

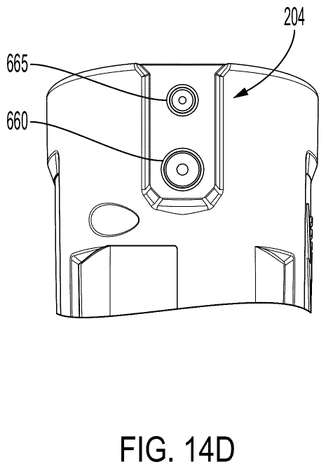

FIG. 15 illustrates a user interface 700 for the heated garment 10. The user interface 700 includes one or more lighting components 705, such as LEDs, that may change color and/or intensity. In some embodiments, the user interface 700 conveys information to a user wearing the heated garment by changing color and/or intensity of the lighting components 705. For example, the lighting components 705 of the user interface 700 may turn OFF when the heater array 26 of the heated jacket 10 is turned OFF (e.g., one of the charger 100 and the holder 200 is disconnected from the heated jacket 10, the battery pack 2 is out of power, etc.). It should be understood that various colors, intensities, blinking patterns, or a combination thereof may be used to convey information via the user interface 700.

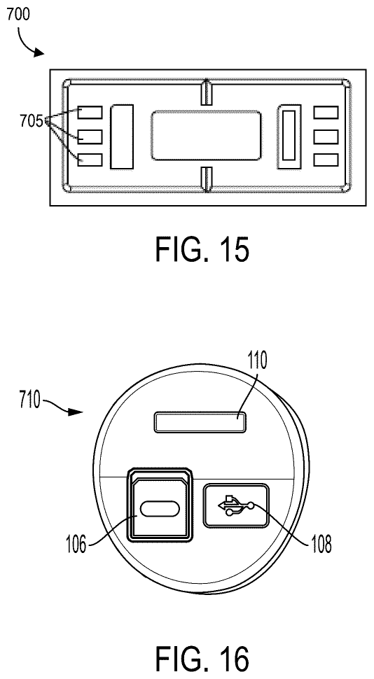

FIG. 16 illustrates a user interface 710 of the charger 100. The user interface 710 includes one or more interactive elements, such as one or more buttons, that send a signal to the charger controller 300 to perform a function and, in some embodiments, one or more passive elements, such as LEDs, that convey information to a user. For example, the user interface 710 may include the cover 106 (covering the bi-directional port 114), the power button 108, and the fuel gauge 110. The power button 108 may be pressed output power from the battery pack 2 to the external device 325 and may be pressed again to disable the flow of power from the battery pack 2 to the external device 325. As another example, the power button 108 may be pressed to enable charging power to flow from the external device 325 to the battery pack 2. The power button 108 may be a back lit button, and the button may be lit (e.g., with a white LED) to indicate that the bi-direction port 114 is on. In other embodiments, the user interface 710 may include an indicator for providing a status of the bi-direction port 114 separate from the power button 108. The fuel gauge 110 may display a level of charge of the battery pack 2 when the battery pack 2 is received by the charger 100. Additionally, the fuel gauge 110 may indicate an error status of one of the charger 100 and the battery pack 2 (e.g., an overcurrent condition, an overtemperature condition, a loss of connection with the external device 325, etc.). In some embodiments, the fuel gauge 110 may include four LEDs, such as, for example, four red LEDs.

FIG. 17 illustrates a power distribution network 800 for the charger 100. As noted above, in some embodiments, the charger 100 provides power to the heated jacket 10 (e.g., from the battery pack 2 connected to the charger 100) and provides power to/receives power from the external device 325 at separate power ports (e.g., the output port 104 and the bi-directional port 114). In some embodiments, the charger 100 provides data along with power to the heated jacket 10. In some embodiments, the charger 100 provides output power to the external device 325 and the heated jacket 10 simultaneously. In some embodiments, the charger 100 receives power from the external device 325 while simultaneously providing power to the heated jacket 10. In embodiments where the charger 100 is receiving input power from the external device 325, the external device 325 may be an inverter coupled to a conventional wall outlet.

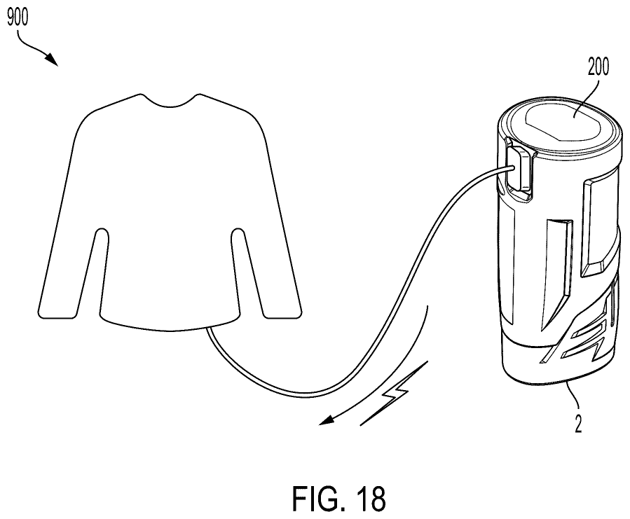

FIG. 18 illustrates a power distribution network 900 for the holder 200. As noted above, in some embodiments, the holder 200 provides power to the heated jacket 10 (e.g., from the battery pack 2 connected to the holder 200). In some embodiments, the holder 200 provides data along with power to the heated jacket 10.

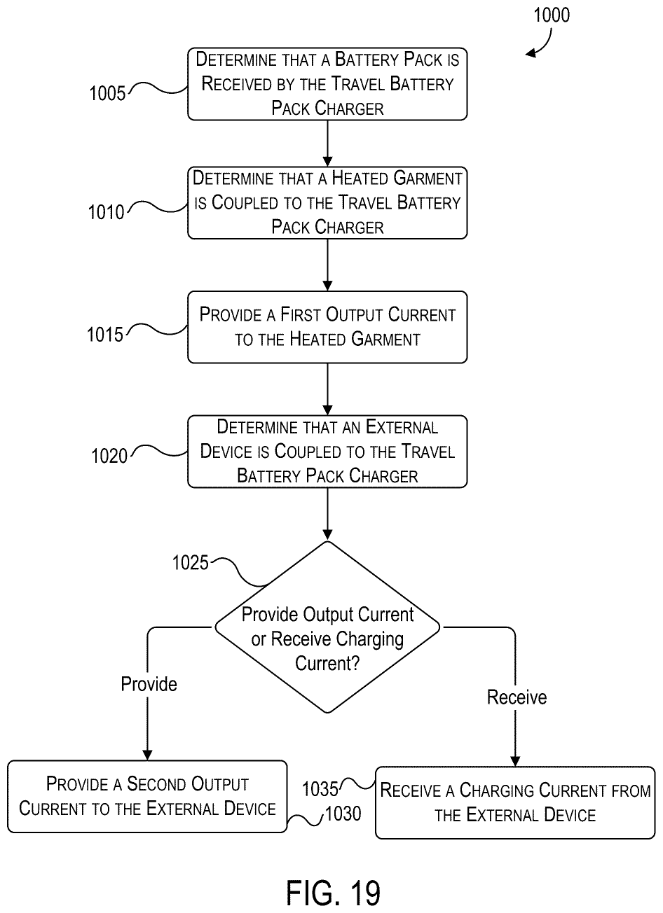

FIG. 19 is a method 1000 for operating the charger 100. Although the illustrated method 1000 includes specific steps, not all of the steps need to be performed or need to be performed in the order presented. In some embodiments, the method 1000 is executed by the charger controller 300 (e.g., by execution of a software program by the processing unit 415).

The method 1000 includes the controller 300 determining that a battery pack 2 is received by the travel battery pack charger 100 (step 1005). In some embodiments, the controller 300 determines that a battery pack 2 is received by the charger 100 based on an input from at least one of a current sensor, a voltage sensor, the terminal block 124, and the power supply interface 320. For example, the controller 300 may determine that the battery pack 2 is received by the charger 100 based on an input from the terminal block 124 when the battery pack 2 is electrically connected to the terminal block 124. In step 1010, the controller 300 determines that a heated garment is coupled to the charger 100. In some embodiments, the controller 300 determines that the heated jacket 10 is coupled to the charger 100 based on an input from at least one of a current sensor, a voltage sensor, the output port 104, and the power supply interface 320.

In step 1015, the controller 300 provides a first output current to the heated garment. For example, the controller 300 facilitates an output current from the battery pack 2 to the heated jacket 10. In some embodiments, the output current flows from the heated garment voltage port 120 to the heated jacket 10. In step 1020, the controller 300 determines that an external device 325 is coupled to the charger 100. In some embodiments, the controller 300 determines that the external device 325 is coupled to the charger 100 based on an input from at least one of a current sensor, a voltage sensor, the bi-directional power port 114, the power supply interface 320, and an input from the power button 108. The external device 325 may be connected to the charger 100 at the bi-directional power port 114.

At decision step 1025, the controller 300 determines whether to provide an output current to the external device 325 or to receive a charging current from the external device 325. In some embodiments, the controller 300 may determine whether to provide an output current to the external device 325 or to receive a charging current from the external device 325 based on an input signal from the power button 108. For example, a single actuation of the power button 108 may send an output current signal to the controller 300 and a quick double-tap actuation of the power button 108 may send a charging current signal to the controller 300. As another example, the controller 300 may determine that the external device 325 contains more stored voltage than available in the battery pack 2. Based upon the determination that the external device 325 has a greater voltage than the battery pack 2, the controller 300 may draw a charging current from the external device 325 to the charger 100 (e.g., so the charger 100 may provide the charging current to the battery pack 2). Alternatively or additionally, in some embodiments, when the controller 300 is actively providing a first output current to the heated jacket 10, the charger 100 may be unable to receive a charging current, thus, the controller 300 may automatically provide an output current to the external device 325 when the external device 325 is coupled to the charger 100 and power is being provided to the heated jacket 10. When the controller 300 determines that an output current will be provided to the external device 325, the method 1000 proceeds to step 1030. When the controller 300 determines that a charging current will be received from the external device 325, the method 1000 proceeds to step 1035.

In step 1030, the controller 300 provides a second output current to the external device 325. In some embodiments, the second output current is less than the first output current. Alternatively, in some embodiments, the second output current is the same as the first output current. In some embodiments, the first output current to the heated jacket 10 decreases when the controller 300 provides the second output current to the external device. In step 1035, the controller 300 receives a charging current from the external device 325. In some embodiments, the controller 300 ceases to provide the first output current to the heated jacket 10 when the controller 300 receives a charging current.

In some embodiments, the controller 300 performs steps 1020-1035 without first performing steps 1005-1015. For example, the controller 300 may provide an output current or receive a charging current to/from the external device 325 while not being coupled to the heated jacket 10.

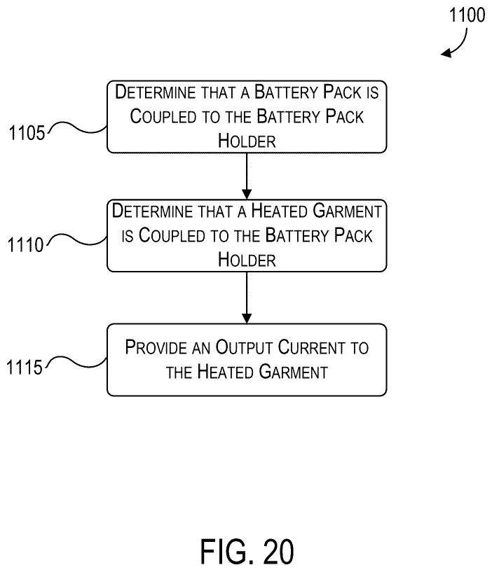

FIG. 20 is a method 1100 of the controller 400 operating the holder 200. Although the illustrated method 1100 includes specific steps, not all of the steps need to be performed or need to be performed in the order presented. In some embodiments, the method 1100 is executed by the battery pack holder controller 400 (e.g., by execution of a software program by the processing unit 530).

The method 1100 includes the controller 400 determining that a battery pack 2 is received by the battery pack holder 200 (step 1105). In some embodiments, the controller 400 determines that a battery pack 2 is received by the holder 200 based on an input from at least one of a current sensor, a voltage sensor, the terminal block 214, and the power supply interface 410. In step 1015, the controller 400 determines that a heated garment is coupled to the holder 200. In some embodiments, the controller 400 determines that the heated jacket 10 is coupled to the holder 200 based on an input from at least one of a current sensor, a voltage sensor, the output port 204, and the power supply interface 410. In step 1115, the controller 400 provides an output current to the heated garment. For example, the controller 400 facilitates an output current from the battery pack 2 to the heated jacket 10. In some embodiments, the output current flows from the heated garment voltage port 212 to the heated jacket.

Thus, embodiments described herein provide, among other things, a travel battery pack charger and a battery pack holder. Various features and advantages are set forth in the following claims.

What is claimed is:

1. A battery pack accessory, comprising:
a cylindrical housing;
a terminal block supported by the cylindrical housing and configured to connect to a battery pack;
an output port provided on the cylindrical housing for providing an output current to a heated garment; and
a controller located within the cylindrical housing and including an electronic processor and a memory, the controller coupled to the terminal block and the output port, the controller configured to:
determine that the battery pack is connected to the terminal block,
determine that the heated garment is coupled to the battery pack accessory at the output port, and
provide the output current to the heated garment in response to determining that the battery pack is connected to the terminal block and the heated garment is coupled to the battery pack accessory at the output port.

2. The battery pack accessory of claim 1, wherein the battery pack accessory is configured to partially receive the battery pack within the cylindrical housing.

3. The battery pack accessory of claim 1, wherein the output port is a dual barrel output port.

4. The battery pack accessory of claim 3, wherein a first barrel of the dual barrel output port is a power port providing the output current to the heated garment and a second barrel of the dual barrel output port is a communication port providing communication signals from the controller to the heated garment.

5. The battery pack accessory of claim 1, wherein the battery pack is a 12 volt (V) battery pack.

6. The battery pack accessory of claim 1, wherein the output port is provided along a longitudinal axis of the cylindrical housing.

7. The battery pack accessory of claim 1, wherein the battery pack accessory is configured to be received by a compartment within the heated garment.

8. The battery pack accessory of claim 1, further comprising:
a bi-directional port provided on the cylindrical housing for providing a second output current to an external device and receiving a charging current from the external device.

9. The battery pack accessory of claim 8, further comprising:
a power button provided on the cylindrical housing,
wherein the controller is further configured to enable the second output current to be provided to the external device via the bi-directional port in response to receiving a signal from the power button when actuated.

10. The battery pack accessory of claim 1, further comprising:
a fuel gauge provided on the cylindrical housing for providing a visual indication of a charge level of the battery pack.

11. A system comprising:
a battery pack, and
a battery pack accessory, the battery pack accessory including:
a cylindrical housing;
a terminal block supported by the cylindrical housing and configured to connect to the battery pack;
an output port provided on the cylindrical housing for providing an output current to a heated garment; and
a controller located within the cylindrical housing and including an electronic processor and a memory, the controller coupled to the terminal block and the output port, the controller configured to:
determine that the battery pack is connected to the terminal block,
determine that the heated garment is coupled to the battery pack accessory at the output port, and
provide the output current to the heated garment in response to determining that the battery pack is connected to the terminal block and determining that the heated garment is coupled to the battery pack accessory at the output port.

12. The system of claim 11, wherein the battery pack accessory further includes:
a first printed circuit board supported by the cylindrical housing.

13. The system of claim 12, wherein battery pack is received by the battery pack accessory at a first end and the first printed circuit board is provided at a second end of the battery pack accessory, wherein the second end is opposite the first end along a longitudinal axis.

14. The system of claim 12, wherein the output port includes a communication port provided on a first side of the first printed circuit board and a voltage port provided a second side, opposite the first side, of the first printed circuit board.

15. The system of claim 12, wherein the battery pack accessory further includes:
a second printed circuit board provided below the first printed circuit board, and
a third printed circuit board provided below the second printed circuit board.

16. A method of providing an output current to a heated garment from a battery pack, the method comprising:
determining, with a controller of a battery pack accessory, that the battery pack is connected to a terminal block of the battery pack accessory;
determining, with the controller of the battery pack accessory, that the heated garment is coupled to the battery pack accessory, wherein the heated garment is coupled to the battery pack accessory at an output port; and
in response to determining that the battery pack is connected to the terminal block and the heated garment is coupled to the battery pack accessory at the output port, providing, with the controller of the battery pack accessory, a first output current from the battery pack to the heated garment.

17. The method of claim 16 further comprising:
determining, with the controller of the battery pack accessory, that an external device is coupled to the battery pack accessory, wherein the external device is coupled to the battery pack accessory at a bi-directional port.

18. The method of claim 17 further comprising:
receiving, with the controller of the battery pack accessory, an output current signal from a power button of the battery pack accessory; and
providing, with the controller of the battery pack accessory, a second output current to the external device in response to receiving the output current signal from the power button and determining that the external device is coupled to the battery pack accessory.

19. The method of claim 17 further comprising:
receiving, with the controller of the battery pack accessory, a charging current signal from a power button of the battery pack accessory; and
receiving, with the controller of the battery pack accessory, a charging current from the external device in response to receiving the charging current signal from the power button and determining that the external device is coupled to the battery pack accessory.

20. The method of claim 16, wherein the output port is a dual barrel port including a first port for providing the output current and a second port for communicating with the heated garment.
